(19) United States
(12) Patent Application Publication
(10) Pub. No.: US 2022/0389352 A1
(43) Pub. Date: Dec. 8, 2022

(54) METHOD AND DEVICE FOR OPTIMISING GREEN MALT FOR A BREWING PROCESS AND THE OBTAINED GREEN MALT

(71) Applicant: BW PROCESTECHNIEK, naamloze vennootschap, Lier (BE)

(72) Inventors: Gert Chapelle, Hove (BE); Guido Aerts, Lievegem (BE)

(73) Assignee: BW PROCESTECHNIEK, naamloze vennootschap, Lier (BE)

(21) Appl. No.: 17/778,312

(22) PCT Filed: Nov. 3, 2020
(86) PCT No.: PCT/IB2020/060303

§ 371 Date: May 19, 2022

(30) Foreign Application Priority Data
Nov. 20, 2019 (BE) 2019/5802

(51) Int. Cl. C12C 1/02; B02C 9/02

(52) U.S. Cl. CPC C12C 1/02; B02C 9/02

(57) ABSTRACT

A method for optimising green malt for a brewing process. The green malt is cut up into cut green malt in a first fragmentation step the cut-up green malt is ground into fragmented green malt in a second fragmentation step. A device for optimising green malt for a brewing process and it also relates to an obtained green malt.

### CROSS-REFERENCE TO RELATED APPLICATIONS

The present application is the National Phase entry of International Patent Application No. PCT/IB2020/060303 filed Nov. 3, 2020 which claims priority to Belgium Patent Application No. 2019/5802 filed Nov. 20, 2019, the contents of which are herein incorporated by reference.

### TECHNICAL FIELD

The present disclosure relates to a method and device for optimising green malt for a brewing process, and to the green malt obtained.

### BACKGROUND

The malting of grains, for example barley, is a necessary preparatory step for brewing beer. During the malting process, grains are transformed into grain malt through germination. This involves the production of malt enzymes, cell wall breakdown and proteolysis to provide the grain embryo with the necessary amino acids. After cleaning and calibration, the cereal grains (moisture content 10 to 12%) are hydrated (soaked) to a moisture content of 40 to 47%. Next, the germination takes place resulting in ‘green’ malt as an end product. Its moisture content makes storage and transport impossible due to mould and bacterial growth. That is why the green malt is subsequently dried as standard and kilned to a moisture content of 4%. The used temperatures up to 82° C. and higher result in a high energy consumption and associated heat load (negative to the taste stability of beer). Loss of important enzyme activities, such as amylase and glucanase activities, can also be noted. From these disadvantages it immediately becomes clear what the advantages are in case of direct use of green malt in the continuation of a brewing process.

U.S. Pat. No. 3,446,708 A describes a process in which fully germinated or modified green malt from thin or small barley grains is shredded into fragments, the green wet fragments are re-formed into pellets without heating and the pellets are kilned to dryness to produce a complete brewing material. The re-formed pellets can be coated with a suitable carbohydrate. In U.S. Pat. No. 3,446,708 A, the shredding of the barley grains aims at a subsequent faster drying of the barley. By drying the barley, important enzyme activities of the barley are lost.

The present disclosure aims to solve at least some of the problems or disadvantages mentioned above.

### SUMMARY

In a first aspect, the present disclosure concerns a method for optimising green malt for a brewing process.

The measure of fragmenting green malt in two sequential steps, in which the green malt is first cut and the green malt thus cut is further fragmented by grinding, in which in the first fragmenting step the green malt is temporarily retained in perforations of a perforated body while a portion of the green malt protrudes from the body, which protruding portion of the retained green malt is cut with a blade, followed by the thus cut green malt being moved through perforations of the perforated body, results in a fragmented green malt which, thanks to its fragmented state, is optimised for going through a brewing process without the green malt having to be dried, i.e. kilned. This offers the advantage that more enzymes from the green malt remain active for the saccharification of starch. In addition, the method is advantageous in that less energy is needed for brewing beer from green malt fragmented according to the method, since the classic step of kilning the green malt and the associated high temperatures and energy costs are avoided. This also reduces carbon dioxide emissions, which is very beneficial for the environment.

In a second aspect, the present disclosure concerns a device for optimising green malt for a brewing process.

In a third aspect, the present disclosure concerns the use of a device according to the second aspect of the present disclosure in a method for optimising green malt for a brewing process according to the first aspect of the present disclosure.

In a fourth aspect, the present disclosure concerns a fragmented green malt, optimised for a brewing process that can be obtained by subjecting green malt to a method according to the first aspect of the present disclosure.

### DESCRIPTION OF THE FIGURES

FIG. 1A schematically illustrates a device for optimising green malt for a brewing process according to embodiments of the present disclosure;

FIG. 1B schematically illustrates an enlarged view of section 1B of FIG. 1A according to embodiments of the present disclosure;

FIG. 2 schematically illustrates a longitudinal section of a perforated disc according to embodiments of the present disclosure;

FIG. 3 schematically illustrates a top view of the perforated disc according to embodiments of the present disclosure; and

FIG. 4 schematically illustrates an alternative device for optimizing green malt for a brewing process according to embodiments of the present disclosure.

### DETAILED DESCRIPTION

Quoting numerical intervals through the endpoints includes all whole numbers, fractions and/or real numbers between the endpoints, including these endpoints.

The term “green malt”, as used in this text, is to be understood as germinated grain comprising chaff and root. In particular, the term “green malt” is to be understood as one or more living starchy granules with a moisture content of 40 to 47%. As a synonym for “living starchy grains”, the term “green malt grains” can also be used. As said green malt grains, grains can be selected from one or several species of starchy crops selected from the group consisting of barley, wheat, oats and sorghum. In some embodiments, the green malt is malted for 3.5 to 7 days, 4 to 6.5 days or 4.5 to 6 days, and after this malting period the green malt has a temperature around room temperature, and in particular a temperature from 19 to 27° C., from 21 to 25° C., or from 22 to 24° C.

The term “substantially equal bend”, as used in this text, can be understood as a bend that deviates maximally 50%, maximally 30%, or maximally 20% from its bent shape in relation to another bend.

The term “substantially equal bending direction”, as used in this text, can be understood as a bending direction that deviates maximally 50%, maximally 30%, or maximally 20% from another bending direction to which it is compared.

The term “substantially transverse”, as used in this text, can be understood as an orientation between 70° and 110° or an orientation between 80° and 100°.

The term “substantially parallel”, as used in this text, can be understood as an approximatively to a fully parallel orientation with a permissible deviation to fully parallel orientation of up to 10°.

The terms “cutting up” or “cutting”, as used in this text, can be understood as completely cutting through a grain, for example, a green malt grain.

In a first aspect, the present disclosure relates to a method for optimising green malt for a brewing process, wherein the green malt is cut up into cut-up green malt in a first fragmentation step and wherein said cut-up green malt is ground into fragmented green malt in a second fragmentation step.

The measure of fragmenting green malt in two sequential steps, in which the green malt is first cut-up and the thus cut-up green malt is further fragmented by grinding, results in a fragmented green malt which, because of its fragmented state, is optimised for going through a brewing process without the green malt needing to be dried, or kilned. This has the advantage that more enzymes from the green malt remain active for the saccharification of starch. In addition, the method offers the advantage that less energy is required for brewing beer from green malt fragmented according to the method, since the classic step of kilning green malt and the associated high temperatures and energy costs are avoided. This also reduces carbon dioxide emissions, which is very beneficial for the environment.

In some embodiments, the method is carried out on green malt which has previously been stored for 0.25 to 2 h, 0.5 to 1.5 h, or 0.8 to 1.2 h at a temperature of 18 to 27° C. or 20 to 25° C. Green malt is a buffered system. Information regarding temperature and pH of the green malt can be used in the next step of cutting the green malt to bring the green malt to the desired temperature and acidity.

In some embodiments, the present disclosure provides a method for optimising green malt for a brewing process according to the first aspect of the present disclosure, wherein before the first fragmenting step, during the first fragmenting step, between the first fragmenting step and the second fragmenting step, or before and during the first fragmenting step and between the fragmenting steps, the green malt is conditioned by spraying the green malt with a water solution at a temperature of 70 to 85° C., 75 to 84° C., even 80 to 83° C., or of about 82° C., and a pH of 3.8 to 4.6, a pH of 3.8 to 4.4, a pH of 3.9 to 4.2, or a pH of 4.0. In order to obtain said pH values, the water is acidified with a food grade acid as known according to the state of the art. In some embodiments, lactic acid is used as acid.

In some embodiments, the present disclosure provides a method for optimising green malt for a brewing process according to the first aspect of the present disclosure, wherein after the first fragmenting step and before the second fragmenting step, during the second fragmenting step and/or after the fragmenting step, after the first fragmenting step and before the second fragmenting step, or during and after the second fragmenting step, the green malt is conditioned by spraying the green malt with a water solution at a temperature of 70 to 85° C., 75 to 84° C., 80 to 83° C., or about 82° C., and a pH of 3.8 to 4.6, a pH of 3.8 to 4.4, a pH of 3.9 to 4.2, or a pH of 4.0. In order to obtain said pH values, water has been acidified with a food grade acid known according to the state of the art. In some embodiments, lactic acid is used as acid.

By combining the second fragmentation step with the conditioning of the green malt, as indicated here, saccharification of the starch is thus started simultaneously with the fragmentation of the green malt, which accelerates the brewing process performed on the basis of the finally obtained fragmented green malt suspension.

According to some embodiments, the green malt is conditioned, with a water solution according to the above parameters, before and during the first fragmentation step, between the first fragmentation step and the second fragmentation step, and during and after the second fragmentation step. It should also be mentioned that the additional aim of conditioning a water solution is to dilute a suspension of green malt in the water solution, as well as to avoid clogging. In addition, according to some embodiments, the water solution is added to the green malt when conditioning the green malt at a flow rate of 1 to 1.5 litres of water solution per kg of green malt.

According to some embodiments, said water solution is brought from a lower temperature, for example room temperature, to said elevated temperatures by direct steam injection.

In some embodiments, the present disclosure provides a method for optimising green malt for a brewing process according to the first aspect of the present disclosure, wherein in the first fragmenting step, the green malt is temporarily retained in perforations of a perforated body while a portion of the green malt protrudes from the body, which protruding portion of the retained green malt is cut up with a blade, and subsequently the thus cut-up green is moved through perforations of the perforated body. Retaining the green malt allows a good cutting-up of the green malt. The blade can be made of any suitable material known in the art. In some embodiments, the blade is made of stainless steel, and in particular stainless steel 304L. In some embodiments, a water solution is added to the green malt during the cutting-up of the green malt and the passage through the perforated body. In some embodiments, the water solution is a water solution with parameters as described for the above embodiments. The water provides a rinse that promotes transport to, through and away from the perforations.

In some embodiments, the present disclosure provides a method for optimising green malt for a brewing process according to the first aspect of the present disclosure, wherein the perforations are oriented at an oblique angle with respect to a surface of the perforated body along which the thus cut-up green malt ends up in the body at the start of the movement through the body. In contrast to a classical transverse orientation of perforations, said oblique orientation of perforations has the advantage that clogging of the perforations is avoided, and in this way temperature increases due to clogging are avoided as well. This is very important for a smooth processing of the green malt and to guarantee a good quality of the green malt. According to some embodiments, said oblique angle is an angle of 5 to 30°, an angle of 10 to 20°, or an angle of 12 to 18° in relation to a fictitious axis that is perpendicular to said surface of the perforated body.

In some embodiments, the present disclosure provides a method for optimising green malt for a brewing process according to the first aspect of the present, wherein the blade rotates in a direction of rotation, for example clockwise or counterclockwise, when cutting up the green malt and wherein the perforations according to a pattern of curved lines in the perforated body are suitable, wherein the curved lines run from a central part to a peripheral part of the body and wherein at least 70%, at least 80%, or 90% of the curved lines extend in a substantially equal bending and a substantially equal bending direction from the central part to the peripheral part, said bending direction being directed according to the direction of rotation of the blade. Said pattern increases the transmission capacity of the perforated body as the curved lines in which the perforations are arranged follow the movement of the blade. In some embodiments, the perforations are also oriented obliquely, as described above, so that an increase of the transmission capacity of 1.6 to 2% can be obtained with respect to a perforated body with classic transverse perforations arranged according to a grid pattern. Said location of the perforations according to said pattern of curved lines is therefore conducive to a rapid movement of green malt through the perforations and moreover prevents clogging of the perforations. A pattern as mentioned above can be created by using a template with a sequence of perforations in an arc, this template being moved clockwise or counterclockwise over an initially non-perforated body during the perforation, so that the perforations can be provided over the entire surface of the body.

In some embodiments, the present disclosure provides a method for optimising green malt for a brewing process according to the first aspect of the present disclosure, wherein after moving the green malt through perforations of the perforated body, a jet of a water solution, substantially transverse to a direction along which the green malt moves through the body in the first fragmentation step, is sprayed on the green malt, and wherein subsequently a second jet of a water solution is sprayed on the green malt in a direction substantially transverse to said first direction and substantially parallel to a surface of the perforated body along which the thus cut-up green malt leaves the body at the end of its movement through the perforations. Thus, the displacement of the green malt from the perforated body is promoted by applying the first jet of a water solution, and this displacement is further promoted by the second water jet of a water solution, which second water jet, due to its orientation, moreover prevents residues of green malt from accumulating after the perforated body. The water solution of the first and/or second jet with which the green malt is sprayed may be water, for example, or a water solution, for example, having the same composition and parameters as the water solution discussed above when conditioning the green malt.

In some embodiments, the present disclosure provides a method for optimising green malt for a brewing process according to the first aspect of the present disclosure, wherein the blade rotates at a speed of 2000 to 4000 rotations per minute, 2300 to 3700 rotations per minute, 2600 to 3400 rotations per minute, or 2900 to 3100 rotations per minute. These rotational speeds are sufficiently high to prevent the blade from not having sufficient force to cut up a green malt grain, so that the green malt can be cut up in a nice straight plane, and at the same time not too high either so as to avoid undesirably high investments in equipment and excessive energy costs.

In some embodiments, the present disclosure provides a method for optimising green malt for a brewing process according to the first aspect of the present disclosure, wherein the blade and the perforated body are spaced apart at most 2.5 mm, at most 2 mm, at most 1.5 mm, at most 1 mm, at most 0.8 mm, at most 0.6 mm, at most 0.4 mm, or at most 0.25 mm. Said distance between said blade and said perforated body ensures a sufficiently fine cutting up of the green malt, since during the start of the movement of a green malt grain through a perforation, a part of the green malt grain still protrudes above the perforated body, and thus thanks to the close distance between perforated body and blade, this protruding part can be finely cut up.

In some embodiments, the present disclosure provides a method for optimising green malt for a brewing process according to the first aspect of the present disclosure, wherein in the second fragmentation step the cut-up green malt is ground by putting the cut-up green malt between a static rough stone body and a rotating rough stone body, wherein said stone bodies are spaced apart at most 1 mm, at most 0.5 mm, at most 0.1 mm, at most 0.05 mm, or at most 0.03 mm, and wherein said stone bodies are spaced apart at least 0.0001 mm, at least 0.0005 mm, at least 0.001 mm, at least 0.005 mm, or at least 0.01 mm. In some embodiments, said stones are spaced about 0.02 mm apart. In some embodiments, the static stone body can be adjusted in height. In some embodiments, the stone bodies are made of a type of stone that is sufficiently hard so that no stone fragments are released during the grinding of the cut-up green malt, and that is sufficiently rough so that the green malt can be ground sufficiently fine during the second fragmentation step. The distance between the static and dynamic stone bodies can be adjusted in any suitable way as known in the art. In some embodiments, the dynamic stone body is located above the static stone body. In some embodiments, the distance between said stone bodies is set via a clock system. In some embodiments, the static stone body is provided with a central cavity for the passage of the green malt. Between the stone bodies, a mill can be placed at the height of said central cavity for additional displacement of the green malt. During the second fragmentation step, said distances between the stone bodies ensure a sufficiently fine grinding of the cut-up green malt into fragmented green malt.

With the method according to the first aspect of the present disclosure, a throughput time of the green malt of at most 3 hours, at most 2.5 hours, or at most 2 hours can be obtained. This is positive for the smooth running of a brewing process on the basis of the green malt. The fragmented green malt can be collected in a classic mashing kettle before filtering the fragmented green malt, for example with a known thin-bed filter. Furthermore, with the method according to the present disclosure, a capacity of 0.7 to 1.4 tons of green malt (or from 0.5 to 1.1 tons of green malt on a dry matter basis) per hour can be easily achieved. In some embodiments, the green malt is placed in water, just before said transfer to a mashing kettle or just before said filtering, for a length of time of 1 to 10 minutes, 3 to 8 minutes, or 4 to 6 minutes, at a temperature of 80 to 95° C., 83 to 92° C., or 85 to 90° C. In this way, any remaining active enzymes in the malt are inactivated.

The method according to the first aspect of the present disclosure is carried out on a continuous basis according to some embodiments. Thus, a continuously performed method according to the present disclosure can also be very favourably adapted to a continuous mashing process.

In a second aspect, the present disclosure concerns a device for optimising green malt for a brewing process, comprising a cutting device suitable for cutting up the green malt into thus cut-up green malt, wherein a grinding device is further arranged in the device, in series with the cutting device, which is to be connected to and, in some embodiments, is connected to the cutting device, and which is suitable for grinding the cut-up green malt into thus finely fragmented green malt.

The measure of arranging said cutting device and said grinding device in series makes the device suitable for fragmenting green malt in two sequential steps, wherein the green malt is first cut up and the thus cut-up green malt is further fragmented by grinding, yields a fragmented green malt which, because of its fragmented state, is optimised to go through a brewing process without the green malt having to be dried, or kilned. This has the advantage that more enzymes from the green malt remain active for the saccharification of starch. In addition, this offers the advantage that less energy is required for brewing beer from green malt fragmented by the device, since the classic step of kilning green malt and the associated high temperatures and energy costs are avoided. This also reduces carbon dioxide emissions, which is very beneficial for the environment.

In some embodiments, the present disclosure provides a device for optimising green malt for a brewing process according to the second aspect of the present disclosure, wherein the cutting device comprises a housing, which housing has a first opening on one side for receiving green malt and has a second opening on another side for allowing cut-up green malt to flow away, and wherein within said housing a counterweight, a perforated disc with perforations and a cutting assembly comprising a blade are arranged around a central rotatable and drivable shaft, the cutting assembly being directed towards said first opening, the counterweight being directed towards said second opening, and the perforated disc being located between the cutting assembly and the counterweight, and wherein the cutting assembly and the counterweight are to be connected, and, in some embodiments, are connected, to the shaft. The blade can be rotated by connecting it to the central shaft. The rotational movement of the blade can be driven by any suitable motor as known in the art. An example is a two-pole 22 kW motor. In some embodiments, the blade is rotated at a rotational speed of 2000 to 4000 rotations per minute, 2300 to 3700 rotations per minute, 2600 to 3400 rotations per minute, or 2900 to 3100 rotations per minute. Said rotational speeds are sufficiently high to avoid that the blade does not have sufficient force to cut up a green malt grain, so that the green malt can be cut up in a nice straight plane, and at the same time not too high either, so that undesirably high investments in equipment and excessive energy costs are avoided. In some embodiments, the blade is made of stainless steel, and particularly stainless steel 304L. The blade can be made of any suitable material known in the art. The perforated disc serves to hold initially received green malt in perforations of the disc, while a portion of the green malt protrudes from the disc, which protruding portion of the retained green malt can be cut up with the blade, and subsequently the thus cut-up green malt can be moved through perforations of the perforated body. The counterweight serves on the one hand to hold the blade in place. In some embodiments, the blade and the perforated disc are spaced apart at a distance of at most 2.5 mm, at most 2 mm, at most 1.5 mm, at most 1 mm, at most 0.8 mm, at most 0.6 mm, at most 0.4 mm, or at most 0.25 mm. In some embodiments, the device is further provided with a screw system suitable to adjust the distance between said blade and said disc and, in some embodiments, capable of adjusting distances with an accuracy of tenths of a millimetre. Said distance between said blade and said perforated disc ensures a sufficiently fine cutting up of the green malt. The counterweight, on the other hand, thanks to its favourable positioning and its rotational movement during the rotation of the blade, contributes to the displacement of green malt introduced into the cutting device, and in particular to a mechanically enhanced displacement of green malt which, after being cut up with the blade, has moved through perforations of the perforated disc, resulting in a better outflow of thus cut-up green malt to the second opening.

In some embodiments of the device according to the second aspect of the present disclosure, said combination of the cutting assembly comprising the blade, perforated body and counterweight is placed in series in duplicate around the central axis in the cutting device. The latter embodiment can be used to further optimise the cutting up or as a safety measure in the event of a failure of an operating disc and/or blade, after which the other combination of the disc, blade and counterweight can be immediately put into operation.

In some embodiments, the present disclosure provides a device for optimising green malt for a brewing process according to the second aspect of the present disclosure, wherein the perforations extend obliquely through the perforated disc. Contrary to a classic embodiment of transversely extending perforations, an obliquely extending arrangement of perforations has the advantage that any clogging of the perforations is avoided, and in this way, temperature increases due to clogging of the perforations by cut-up green malt can also be avoided. This is very important for a smooth fragmentation of green malt by the cutting device and to ensure a good quality of the green malt. According to some embodiments, said perforations extend through the perforated disc at an angle of 5 to 30°, an angle of 10 to 20°, or an angle of 12 to 18° in relation to a fictitious axis which is perpendicular to a surface of the perforated body, along which surface green malt is received when in use.

In some embodiments, said perforations have a diameter which is 60 to 100%, 70 to 95%, or 75 to 90% of the smallest diameter of green malt grains to be cut up. The smallest diameter means the diameter according to the smallest dimension of a green malt grain. In some embodiments, the perforations have a diameter of 2 to 7 mm, 3 to 6 mm, or 3.5 to 5 mm. Such dimensions of the diameter of the perforations are equal to or slightly smaller than the smallest diameter of the green malt grains, which is ideally suited for holding green malt during cutting, which promotes a good cutting of the green malt. According to some embodiments, the perforations of one side of the perforated disk, which faces the first opening of the cutting device when in use, widen towards a side of the perforated disk which, when in use, faces the second opening of the cutting device. This allows cut-up green malt to move better through the perforations and it is also a measure to prevent clogging of the perforations.

In some embodiments, the present disclosure provides a device for optimising green malt for a brewing process according to the second aspect of the present disclosure, the blade being designed as a downward facing wing-shaped body, the body comprising two wings extending in line which, when in use, are directed downward to the perforated disc of the cutting device, and which wings have a cutting edge on one side of the wings facing the perforated disc when in use. The downward orientation of the wings ensures a downward and inward displacement of green malt trapped in the cutting device, so that the green malt is optimally presented to be cut up while being held by the perforations of the disc and then displaced through the perforations.

In some embodiments, the present disclosure provides a device for optimising green malt for a brewing process according to the second aspect of the present disclosure, wherein between said first opening of the cutting device's housing and the cutting assembly a liquid pipe is provided which allows for a liquid connection, and, in some embodiments, is connected to the housing, and/or wherein between said second opening of the cutting device's housing and the counterweight a liquid pipe is provided which allows for a liquid connection, and, in some embodiments, is connected to the housing. According to some embodiments, both said liquid pipes are provided. A liquid pipe makes it possible to provide a liquid, for example water or an aqueous solution, in the housing. The supply of a liquid is advantageous to promote the general flow of green malt through the cutting device and to prevent clogging of perforations of the perforated disc with green malt.

In some embodiments, the present disclosure provides a device for optimising green malt for a brewing process according to the second aspect of the present disclosure, wherein in said housing of the cutting device and facing the counterweight, a first and a second spray tube, each comprising a spray tube body ending in a nozzle, are placed, which spray tube bodies are in line with each other, and wherein said nozzle of the first spray tube is directed towards the counterweight, and the nozzle of the second spray tube is oriented at an angle of 80° to 100° with respect to the spray tube body of the second spray tube. Thus, with the first spray tube, a liquid can be sprayed substantially transversely to a direction along which cut-up green malt, received through the first opening of the cutting device and cut-up by the blade of the cutting device, moves out of perforations of the perforated disk, and wherein subsequently, with the second spray tube, a liquid is sprayed on the cut-up green malt in a direction substantially transverse to said first direction and substantially parallel to the perforated disc. Thus, displacement of the green malt out of the perforated disc is enhanced by the use of a liquid sprayed from the first liquid pipe, and this displacement is further enhanced by a liquid sprayed by a second liquid pipe, which second sprayed liquid by its orientation also prevents green malt residue from accumulating after the perforated disc. The liquid administered via the first and/or second spray tube may be, for example, water or, for example, a water solution having the same composition and parameters as the water solution discussed above. According to some embodiments, said spray tubes are arranged in the vicinity of said counterweight.

In some embodiments, the device according to the second aspect of the present disclosure comprises a dosing device suitable for dosing green malt to be received and which is to be connected, and, in some embodiments, is connected, to the first opening of the housing of the cutting device. The dosing device is used to regulate the supplied volume of green malt. In some embodiments, the dosing device is designed to be frequency-controlled. In some embodiments, the dosing device comprises a tubular or funnel-shaped casing arranged substantially at right angles to a screw conveyor. Said casing comprises an inlet suitable for receiving green malt and an outlet for supplying the green malt to the screw conveyor. By the screw conveyor the transport of the green malt can be carried out at a desired transport speed. In some embodiments, the rotation of the screw conveyor around its shaft is obtained by driving this shaft via a motor. Any suitable motor as known in the art can be used for this purpose. In some embodiments, the motor is frequency-controlled. According to some embodiments, the dosing device comprises a paddle or bridge breaker within said casing. The paddle prevents the formation of granules in the supplied material and thus clogging of the dosing device.

In some embodiments, the device according to the second aspect of the present disclosure comprises, between the cutting device and the grinding device, a pumping device which is to be connected, and, in some embodiments, is connected to, both the cutting device and grinding device and which is suitable for displacing cut-up green malt from the cutting device to the grinding device. The pumping device can be any suitable pump as known in the art. For example, a peristaltic pump or an eccentric screw pump can be selected. In some embodiments, an eccentric screw pump is chosen. According to some embodiments, an eccentric screw pump is selected in which a press system comprising a screw conveyor is added at the inlet of the screw pump. The aforementioned screw thread ensures a mechanical propulsion of the green malt and prevents clogging of the pump.

In some embodiments, the present disclosure provides a device for optimising green malt for a brewing process according to the second aspect of the present disclosure, wherein the grinding device comprises a housing, which housing is provided with a first opening for receiving cut-up green malt on one side and with a second opening for letting fragmented green malt flow out on the other side, and wherein within said housing are provided a rough dynamic stone disk to be centrally connected around a rotatable central shaft and a rough static stone disk comprising a central cavity, wherein the stone discs are arranged opposite each other and wherein the central cavity of the static stone disc faces the dynamic stone disc, and wherein the static stone disc faces said first opening and the dynamic stone disc faces said second opening. Through the central cavity of the static stone disc, received cut-up green malt can move between the two stone discs. The cut-up green malt can then be ground between the stone discs. In some embodiments, the mutual distance between the stone discs is at most 1 mm, at most 0.5 mm, at most 0.1 mm, at most 0.05 mm, or at most 0.03 mm. In some embodiments, the mutual distance between the stone discs is at least 0.0001 mm, at least 0.0005 mm, at least 0.001 mm, at least 0.005 mm, or at least 0.01 mm. In some embodiments, said stones are spaced about 0.02 mm apart. In some embodiments, the stone bodies are made of a type of stone that is sufficiently hard, so that no stone fragments are released during the grinding of the cut-up green malt, and which is sufficiently rough so that the green malt can be ground sufficiently fine between the stone discs. In some embodiments, the grinding device is further provided with a clock system for setting the distance between said stone discs. A mill can be placed between the stone discs at the height of said central cavity for additional displacement of the green malt. The above-mentioned distances between the stone discs allow for a sufficiently fine grinding of the cut-up green malt into fragmented green malt.

In some embodiments, the present disclosure provides a device for optimising green malt for a brewing process according to the second aspect of the present disclosure, wherein between said first opening of the housing of the grinding device and the static stone disc is provided a liquid pipe which allows for a liquid connection, and, in some embodiments, is connected to the housing, and/or wherein between said second opening of the housing of the grinding device and the dynamic stone disc, a liquid pipe is provided which is allows for a liquid connection, and, in some embodiments, is connected to the housing. According to some embodiments, both said liquid pipes are provided. A liquid pipe makes it possible to provide a liquid, for example water or an aqueous solution, in the housing. Supply of a liquid is advantageous to promote the general flow of green malt through the grinding device, with the right conditions of the liquid to start the gelatinization and saccharification of the starch present, and to prevent clogging of green malt between the stone discs of the grinding device.

According to some embodiments of the device according to the second concept of the present disclosure, the latter are equipped with a temperature sensor and/or a flowmeter, and, in some embodiments, equipped with a temperature sensor and a flowmeter. Any suitable temperature sensor and/or flow meter can be used for this purpose. A non-limiting example of a suitable temperature sensor is a PT100 sensor. A non-limiting example of a suitable flow meter is a FIC (Flow Indicating Control) flow meter. In one embodiment, a desired liquid temperature can be obtained by mixing hot liquid from a hot liquid pipe and cold liquid from a cold liquid pipe.

According to some embodiments of the device according to the second aspect of the present disclosure, the capacity of the grinding device is greater than the capacity of the cutting device. This provides a suction effect or an emptying effect, which helps to avoid clogging in the cutting device. It goes without saying that this difference in capacity is not too great either, because otherwise there is a risk that the green malt cannot be cut up sufficiently fine in the cutting device. In some embodiments, the capacity of the grinding device is 1.05 to 1.6 times greater, 1.10 to 1.5 times greater, 1.15 to 1.45 times greater, or 1.2 to 1.4 times greater than the capacity of the cutting device.

According to some embodiments, the various parts of the device according to the second aspect of the present disclosure can be screwed together. This allows for easy installation of the device on site.

In a third aspect, the present disclosure relates to the use of a device according to the second aspect of the present disclosure in a method for optimising green malt for a brewing process according to the first aspect of the present disclosure. Accordingly, all technical realisations and positive features of a device according to the second aspect of the present disclosure are combined with those of a method according to the first aspect of the present disclosure.

In a fourth aspect, the present disclosure relates to a fragmented green malt optimised for a brewing process that is available, or obtained, by subjecting green malt to a method according to the first aspect of the present disclosure. For the technical characteristics and advantageous effects of such a fragmented green malt, reference is made to the above description of the method according to the first aspect of the present disclosure.

In what follows, the present disclosure is described with reference to non-limiting examples or figures illustrating the present disclosure, and which are not intended or should be interpreted to limit the scope of the present disclosure.

### EXAMPLES

### Example 1

Example 1 relates to a method and device for optimising green malt for a brewing process according to embodiments of the present disclosure.

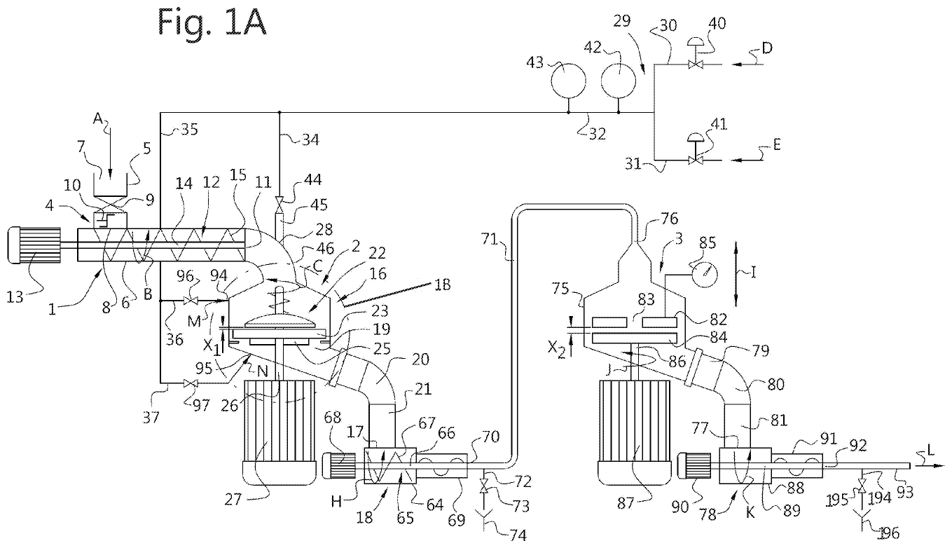

To better illustrate Example 1, reference is made to FIG. 1A and the detail of FIG. 1A in FIG. 1B. FIG. 1A shows a schematic representation of a device for optimising green malt for a brewing process according to embodiments of the present disclosure.

First, the general steps of the method according to Example 1 are explained here. With the aid of a dosing device 1, green malt can be transferred in a desired dosage to a cutting device 2, where the green malt is cut up in a first reducing step. Subsequently, the thus cut-up green malt is ground in a second reducing step in a grinding device 3 to a fragmented green malt. In general, during the process, water contributes to a rinsing and transport through the device of Example 1. The green malt thus fragmented is optimised for a brewing process. Thanks to its fragmented state, the fragmented green malt is optimised for going through a brewing process without the green malt having to be dried, or kilned.

When water or a water solution is referred to during the method according to Example 1, a water solution is selected to that end at a temperature of 70 to 85° C., 75 to 84° C., 80 to 83° C., or about 82° C., and a pH of 3.8 to 4.6, a pH of 3.8 to 4.4, a pH of 3.9 to 4.2, or a pH of 4.0. In order to achieve said pH values, water can be acidified with a food grade acid, such as lactic acid, as known according to the state of the art. At said temperatures and pH values of water, undesired enzymes such as lipoxygenase present in the green malt will be rapidly inactivated after mixing with green malt. However, enzymes responsible for starch saccharification in the green malt, including beta-amylase, alpha-amylase and limit dextrinase, will be activated under these conditions, so that the starch saccharification can be initiated. In this way, the green malt is additionally optimised for a brewing process.

What follows now is the detailed description of the method and device according to Example 1. The dosing device 1 comprises a housing 4 comprising a first leg 5 and a second leg 6, which legs 5, 6 are arranged perpendicular to each other and are in open connection with each other. The first leg 5 of the housing 4 comprises a first opening 7 facing an environment, and a second opening 8 that forms an open connection with said second leg 6 of the housing 4. The first opening 7 is intended to receive green malt which is administered to this opening 7 in a direction A facing the first opening 7. Via the second opening 8, the green malt can then flow through to the second housing 4 of the dosing device 1. Said openings 7, 8 are situated on either side of the first leg 5, and between said openings 7, 8 the first leg 5 is provided with a constriction 9. The constriction 9 serves to channel supplied green malt, so that the green malt can flow in a controlled manner to the second housing 4. Between said constriction 9 and the second opening 8 of the first leg 5 is provided a paddle 10. The paddle 10 avoids granulation of supplied green malt and thus avoids clogging of the dosing device 1. The second leg 6 of the housing 4 of the dosing device 1 comprises an outlet 11 which is in open connection with said cutting device 2. Centrally located in the second leg 6 and directed towards said outlet 11 is a screw conveyor 12 connected to and driven by an external drive 13. The screw conveyor 12 comprises a shaft 14 and a helical screw blade 15 arranged around the shaft 14. By a driven rotational movement B about its shaft 14, green malt can be transported in a controlled manner via the screw blade 15 to the cutting device 2. Thus, the dosage of the green malt is controlled, or in other words the supplied volume per unit of time, i.e. the flow rate of the supplied green malt, is set in a controlled manner.

By controlled transport of the green malt via the screw conveyor 12, the green malt is transferred to the cutting device 2. The cutting device 2 comprises a housing 16 comprising a casing 46 and a first opening which coincides with the outlet of the second leg 6 of the housing 4 of the dosing device 1, and which inlet is in open connection with said dosing device 1, and which housing 16 of the cutting device 2 further comprises a second opening 17 in open connection with a first pumping device 18. As shown, the housing 16 of the cutting device 2 is composed of various parts 19, 20, 21 that can be mutually connected. Such a modular construction facilitates on-site assembly of the device.

The housing 16 of the cutting device 2 also includes a first liquid supply inlet 28 in connection with the casing of the housing 16, in the vicinity of the housing 4 of the dosing device 1. Via this first liquid supply inlet 28, water or a water solution at a controlled temperature of about 85° C. can be added. This is ideal for bringing the supplied green malt to a suitable temperature and maintaining it there during transport by the screw conveyor 12 and just before cutting up the green malt in the cutting device 2 is started. The liquid supply inlet 28 is especially designed to receive water or a water solution from a liquid supply system 29. The liquid supply system 29 comprises several liquid supply pipes 30-32, 34-37 in communication with each other. The temperature of water or a water solution conveyed by the liquid supply system 29 can be controlled by mixing hot and cold water or a hot and cold water solution. This allows hot water or a hot water solution to be supplied through a liquid pipe 30 and cold water or a cold water solution to be supplied through another liquid pipe 31, which two liquid pipes 30, 31 converge in yet another liquid pipe 32, so that by mixing hot and cold water or a hot and cold water solution a desired water temperature can be obtained. Quantities of hot and cold water or a hot and a cold water solution can be controlled by taps 40, 41 provided on the respective liquid pipes 30, 31. Said liquid pipe 32 in which the hot and cold water or the hot and cold water solution come together is equipped with a flow meter 42 and a temperature sensor 43, so that the flow rate and temperature of the water or the water solution, respectively, can be monitored. Via a branched pipe 34 of the liquid supply system 29 and along a valve 44, water or a water solution is supplied to a pipe 45 communicating with said first liquid supply inlet 28 of the housing 16 of the cutting device 2, and thus water or a water solution at a controlled temperature of 20 to 25° C. can be fed to the casing 46 of the housing 16.

In said housing 16, the cutting device 2 comprises a cutting assembly 22 comprising a blade 47, a perforated disc 23 with perforations 24 and a counterweight 25. Said cutting assembly 22, perforated disc 23 and counterweight 25 are centrally arranged around a shaft 26. The cutting assembly 22 and the counterweight 25 are connected to one another and at the same time suspended around the shaft 26, so that upon a rotational movement of the shaft, the cutting assembly 22 and counterweight 25 rotate along. The shaft 26 is connected to an external drive 27 which supplies power to cause the shaft 26 to move in a rotational direction C about its axis. The perforated disc 23 is located between the cutting assembly 22 and the counterweight 25. The counterweight 25 serves to keep the cutting assembly 22 at a predetermined distance X1 with respect to the perforated disc 23. Said distance X1 can be adjusted by a screw system suitable to adjust the distance between said cutting assembly and said disc and which is able to set distances to an accuracy of tenths of a millimetre (not shown in FIG. 1A). The blade 47 is designed as a downward-facing wing-shaped body 47 comprising two wings 48, 49 extending in line, which wing-shaped body 47, on a first side 50, has surface notches 51, 52 on each wing 48, 49. Said notches 51, 52 serve to facilitate the movement of the wing-shaped body 47 in a mass of green malt. Said wings 48, 49 are directed downwards towards the perforated disc 23 of the cutting device 2, which downward direction has the advantage that upon rotation of the cutting assembly 22 a downward and inward displacement of supplied green malt is obtained, so that the green malt is optimally presented to be cut up by the cutting assembly 22 and then displaced through the perforations 24 of the perforated disc 23. A second side 53 of the wing-shaped body 47, which second side 53 is located opposite said first side 50, is provided with a cutting surface 54 which is located at said distance X1 in relation to the perforated disc 23 when in operation. According to Example 1, the shaft 26, and consequently the cutting assembly 22, is rotated at a speed of 2900 to 3100 rotations per minute. Said rotational speeds are sufficiently high to prevent the cutting assembly 22 according to Example 1 from not having sufficient force to cut a green malt grain, so that the green malt can be cut up according to a nice straight plane. The blade can be made of any suitable material known in the art. In some embodiments, the blade is made of stainless steel, and in particular of stainless steel 304L.

In said housing 16 of the cutting device 2, facing the counterweight 25, are placed a first 60 and a second 61 spray tube, which spray tubes 60, 61 are in line with each other. Said first spray tube 60 includes a nozzle 62 facing the counterweight 25. Said second spray tube 61 comprises a nozzle 63 which is oriented at an angle γ of 90° with respect to the second spray tube 61. Thus, the first spray tube 60 can flush cut-up green malt in a first direction F with water or a water solution, after which the second spray tube 61 can flush away any cut-up green malt that has not yet been flushed away in a direction G transverse to said first direction. This is a very effective arrangement to avoid residual cut-up green malt that has not been washed away.

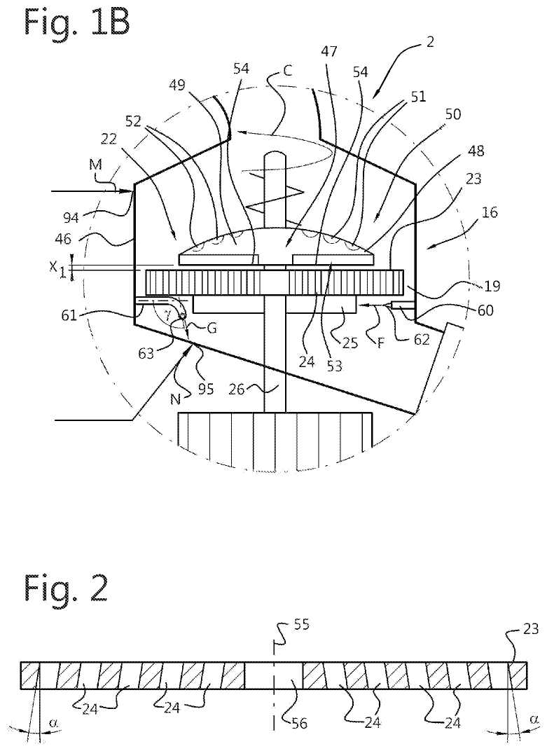

FIG. 2 shows a detail of a longitudinal section of a perforated disc 23. In this representation, the location of the perforations 24 through the perforated disc 23 becomes clear. The perforations 24 are provided obliquely through the perforated disc 23. With respect to a fictitious axis 55 which is perpendicular to the perforated disc 23, the perforations 24 are oriented according to an angle α of 15°. In contrast to a classical transverse arrangement of perforations 24, an oblique arrangement of perforations 24 has the advantage that clogging of the perforations 24 is avoided, and moreover temperature increases due to clogging are avoided. This is very important for a smooth processing of the green malt and to guarantee a good quality of the green malt. In FIG. 2, the central cavity 56 of the perforated disc 23 is also illustrated, in which cavity 56 the shaft 26 of the cutting device 2 can be placed.

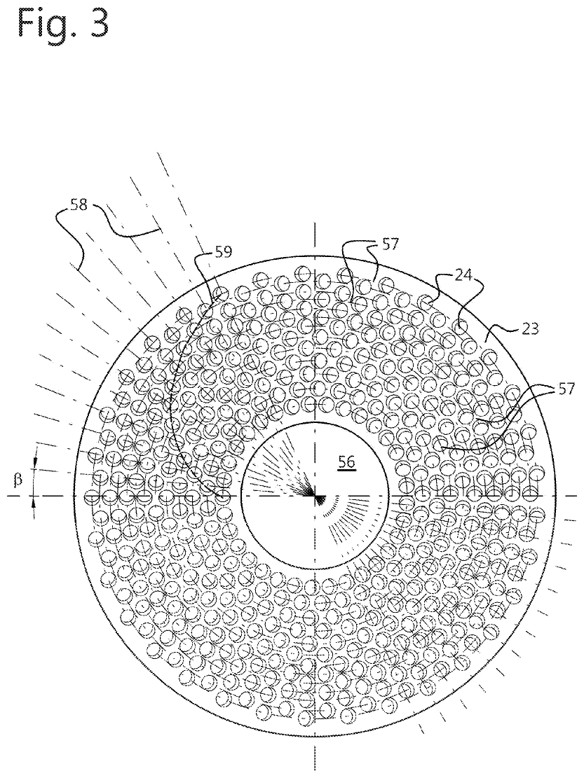

FIG. 3 shows a detail of a top view of a perforated disc 23. It clearly shows that the perforations 24 are arranged along concentric rows 57 around the cavity 56. Seen from the centre of the cavity 6, the perforations 24 are also arranged in rays 58, which rays 58 are situated at an angle β between 5° and 6° with respect to each other. Furthermore, the perforations 24 are arranged along curved lines 59 along which perforations 24 are provided lengthwise across the perforated disc 23. Perforations arranged along said curved lines 59 are provided line by line by a suitable template. The arrangement of the perforations 24 along the curved lines 59 follows a rotational movement of the cutting assembly 22. In this way, the perforations 24 in the perforated disc 23 are ideally suited to receive green malt grains that are cut up by the cutting assembly 22.

In the perforations 24 of the perforated disc 23, green malt grains can be temporarily retained while a portion of the green malt protrudes from the perforated disc 23, which protruding portion of the retained green malt is cut up with the blade 47, and then the thus cut-up green malt is moved through the perforations 24 of the disc 23. Retaining the green malt allows a good cutting of the green malt.

Via liquid pipes 36, 37 branching off from said liquid supply system 29, water or a water solution can be added into the cutting device. For this purpose, the housing 16 of the cutting device 2 includes a first access 94 above the cutting assembly 22 and a second access 95 below the counterweight 25. Of said liquid pipes 36, 37, a liquid pipe 36 communicates with said first access 94, and a liquid pipe communicates with said second access 95. Both liquid pipes 36, 37 are each provided with a valve 96, 97. Through said first access 94, water or a water solution can flow through said liquid pipe 36 in a direction M above the cutting assembly 22 into the cutting device 2. Via said second access 95, water or a water solution can flow through said liquid pipe 37 in a direction N below the counterweight 25 into the cutting device.

Via said second opening 17 of the housing 16 of the cutting device 2, cut-up green malt then enters the first pumping device 18. The first pumping device 18 comprises a housing 64 in which a screw conveyor 65 is arranged to move the cut-up green malt. Said screw conveyor 65 comprises a shaft 66 and a helical screw blade 67. The shaft 66 is connected to and driven by an external drive 68, so that the shaft 66 can move about its axis in a rotational movement H. In addition, said housing 64 of the first pumping device 18 comprises an eccentric screw pump 69 arranged in line with respect to said screw conveyor 65. The combination of screw conveyor and eccentric screw pump is ideally suited for moving the cut-up green malt. In line with the eccentric screw pump 69 and opposite to the screw conveyor 65, the housing 64 is provided with an outlet 70. Connected to the outlet 70, the device according to Example 1 comprises a pipe 71 which opens into the grinding device 3. Said pipe 71 is also branched off by a control pipe 72, which control pipe 72 is equipped with a valve 73. By the control pipe 72, samples can easily be taken by a first sample-taking device 74.

By said first pumping device 18, the cut-up green malt is conveyed to the grinding device 3. The grinding device 3 comprises a housing 75 with a first opening 76 for receiving cut-up green malt, which first opening 76 is in open connection with said pipe 71 for conveying cut-up green malt, and which housing 75 of the grinding device 3 further has a second opening 77 in open communication with a second pumping device 78. As shown, the housing 75 of the grinding device 3 is composed of several mutually attachable parts 79, 80, 81. Such a modular construction makes it easier to assemble the device on site. In said housing 75, the grinding device 3 comprises a rough static stone disc 82 in which a central cavity 83 is provided, and the grinding device 3 in said housing 75 comprises a rough dynamic stone disc 84. The stone discs 82, 84 are made of a stone that is sufficiently hard so that no stone fragments are released during the grinding of cut green malt, and that it is sufficiently rough so that the cut-up green malt can be ground sufficiently fine. Said stone discs 82, 84 are located at a well-defined distance X2 of 0.2 mm from each other. The distance between the stone discs 82, 84 is adjustable by moving the static stone disc 82 up or down in a vertical direction I. Such a vertical direction I can be exerted by manipulating a clock system 85 connected to the rough static stone disc 82. Said rough dynamic stone disk 84 is centrally connected to a shaft 86, which shaft 86 is connected to and driven by an external drive 87. Around the shaft 86, the rough dynamic disk 84 can be rotated according to a rotational movement J, by which rotational movement the cut-up malt grains can be ground between the stone discs 82, 84.

Cut-up green malt is introduced into the second pumping device 78 via the second opening 77 of the grinding device 3. The second pumping device 87 comprises a housing 88 in which a shaft 89 is mounted, which shaft 89 is connected to and driven by an external drive 90, so that the shaft 89 can move about its axis in a rotational movement K. Said shaft 89 drives an eccentric screw pump 91, also present in the housing 88. In line with the eccentric screw pump 91 and opposite the shaft 89, the housing is provided with an outlet 92, along which the cut-up green malt can be further conveyed via a pipe 93 in a direction L in order to be further processed in a brewing process, in which the cut-up green malt can, for example, be transferred to a mash ton. The latter pipe 93 is also branched off by a control pipe 194, which control pipe 94 is equipped with a valve 195. By the control pipe 194, samples can easily be taken by a second sample-taking device 196.

### Example 2

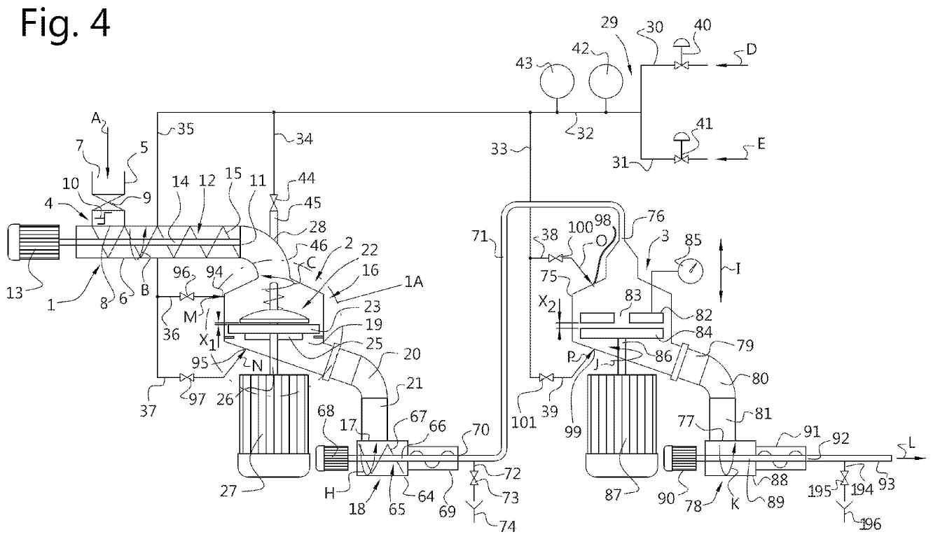

Example 2 is shown in FIG. 4. Example 2 is identical to Example 1 (FIG. 1A), except for additional liquid pipes 33, 38, 39 of the liquid supply system 29. Via liquid pipes 38, 39 which branch off from the liquid supply system 29, water or a water solution can be added into the grinding device 3. For this purpose, the housing 75 of the grinding device 3 includes a first access 98 above the rough static stone disc 82 and a second access 99 below the rough dynamic stone disc 94. From said liquid pipes 38, 39 there is a pipe 38 in communication with said first access 98, and a pipe 39 communicates with said second access 99. Both pipes 38, 39 are each equipped with a valve 100, 101. Through said first access 98, water or a water solution can flow via said pipe 38 in a direction O above the rough static stone disc 82 into the grinding device 3. Through the second access 99 mentioned above, water or a water solution can flow via said pipe 39 in a direction P under the rough dynamic stone disc 94 into the grinding device 3.

### Example 3

Example 3 concerns comparative brewing tests in which a brewing test starting from a fragmented green malt according to the present disclosure is compared with a brewing test starting from a fragmented traditionally dried malt or oats malt. Both the fragmented green malt and the dried malt were obtained from 6-row Etincel barley. A fragmented green malt according to the present disclosure refers to a fragmented green malt obtained by subjecting green malt to a method according to the first aspect of the present disclosure, wherein a design according to the second aspect of the present disclosure was used to carry out the method. The following describes the different steps of the brewing tests and shows test results of obtained worts and beers. The displayed test results, which are highly desirable from a brewing point of view in the case of the brewing test starting from fragmented green malt, clearly show that a fragmented green malt obtained according to the present disclosure is optimised for going through a brewing process without the green malt having to be dried, i.e. kilned.

Brewing test based on a fragmented green malt according to the present disclosure

For the brewing test based on a fragmented green malt according to the present disclosure, 507 kg or 269 kg of dry matter of a fragmented green malt with a moisture content of 47% is used. Process water is acidified with lactic acid to pH 4.0, enriched with CaCl₂.H₂O (100 ppm Ca²⁺) and heated to 85° C. The total amount of water added during the fragmentation of original green malt is 6.2 hl. The grinding was carried out under water with a cutting and grinding device: cutting device with perforated (4 mm) discs with oblique blade (rotational speed of 3000 rotations/min) followed by grinding device (0.02 mm distance between stone discs and rotational speed of 3000 rotations/min of dynamic stone disc).

In this way a mash ratio of 269 kg (dry matter) and 850 litres of water (total) is obtained, i.e. 1/3.15. The total fragmentation time is 35 min. At the start of the fragmentation, 54 g Brewtan B is dissolved in the process water.

The temperature at the start of the mashing is 60° C. and the pH=5.5. At the end of the mashing, the temperature is 63° C. 60 min rest at 63° C., 30 min rest at 72° C. and heat to 85° C. for wort filtration.

Wort filtration is carried out over a thin-bed filter with 27 plates at a dosage of 11 kg per plate: filtration time for main wort is 35 min. Total volume after filtration and filter washing is 12 hl at 14° P.

At the start of a boiling process, 790 g of Columbus bitter hops (14.9% alpha acids) are added. It is boiled for 1 hour. After boiling, the wort is transferred to a whirlpool. After 15 minutes rest, 1.2 g Saaz hops are added per litre of wort. 30 minutes later, the cooling is started by transfer via a plate cooler and centrifuge to a fermentation tank.

About 10 hl at 15° P is then used for the fermentation. At the start, 1000 g of dry granular yeast is added. Fermentation takes place at 14° C. under 100 mbar pressure. Final fermentation (residual extract 2.6° P) is reached after 5 days

Comparative Brewing Test Starting from a Fragmented Kiln Malt

For the brewing test starting from a fragmented kiln malt, 254 kg or 244 kg of dry matter of a fragmented kiln malt with a moisture content of 4% is used. Process water is acidified with lactic acid to pH 4.0, enriched with CaCl₂.H₂O (100 ppm Ca^{t}) and heated to 70° C. The total amount of water added during the fragmentation of the original kiln malt is 6.1 hl. The grinding was carried out under water with a cutting and grinding device: cutting device with perforated (4 mm) discs with oblique blade (rotational speed of 3000 rotations/min) followed by grinding device (0.10 mm distance between stone discs and rotational speed of 3000 rotations/min of dynamic stone disc).

In this way a mash ratio of 244 kg (dry matter) and 610 l water (total) is obtained, i.e. 1/2.5. The total fragmentation time is 35 minutes. At the start of the fragmentation, 54 g of Brewtan B dissolved in 1 l of water is added.

The temperature at the start of the mashing is 62° C. and the pH=5.4. At the end of the mashing, the temperature is 63° C. Rest for 60 min at 63° C., rest for 30 min at 72° C. and heat to 85° C. for wort filtration.

Wort filtration is carried out over a thin-bed filter (with 27 plates at a dosage of 11 kg per plate: filtration time for main wort is 45 min. Total volume after filtration and filter washing is 11.5 hl at 13° P.

At the start of the boiling process, 750 g of Columbus bitter hops (14.9% alpha acids) are added. It is boiled for 1 hour. After boiling, the wort is transferred to a whirlpool. After 15 minutes rest, 1.2 g Saaz hops are added per litre of wort. 30 min later, cooling is started by transfer via the plate cooler and centrifuge to a fermentation tank.

Approximately 10 hl at 14° P is then used for fermentation. At the start, 1000 g of dry granular yeast is added. Fermentation takes place at 14° C. under 100 mbar pressure. Final fermentation (residual extract 3.8° P) is reached after 6 days.

Test Results of Comparative Brewing Tests

Table 1 shows results of worts obtained with the fragmented green malt according to the present disclosure and Table 2 shows results of worts obtained from the fragmented kiln malt.

TABLE 1
Results of worts obtained with the fragmented
green malt according to Example 3

| | | | |
|---|---|---|---|
| Wort before | DMS* (ppb) | | 168.2 ± 23.0 |
| cooking | | | |
| | DMSP** (ppb) | | >2700 |
| | Aldehydes (ppb) | 2-methylpropanal | >106.0 |
| | | 2-methylbutanal | 43.7 ± 3.5 |
| | | 3-methylbutanal | 120.6 ± 11.2 |
| | | hexanal | 48.8 ± 0.6 |
| | | furfural | 6.1 ± 0.0 |
| | | methional | 124.8 ± 0.3 |
| | | benzaldehyde | 3.2 ± 0.1 |
| | | phenylacetaldehyde | 86.2 ± 3.1 |
| | | (E)-2-nonenal | 0.34 ± 0.03 |
| | Sugars (g/l) | glucose | 23.4 ± 0.5 |
| | | maltose | 111.2 ± 1.8 |
| | | dp3*** | 30.3 ± 0.5 |
| | | dp4**** | 6.5 ± 0.1 |
| | | dp5***** | 1.6 ± 0.1 |
| | | dp6† | 1.7 ± 0.2 |
| | | dp7†† | 1.2 ± 0.1 |
| | | dp8††† | 1.9 ± 0.2 |
| Wort end of | DMS (ppb) | | 76.2 ± 0.4 |
| cooking | | | |
| | DMSP (ppb) | | 40.6 ± 0.6 |
| | Aldehydes (ppb) | 2-methylpropanal | 39.7 ± 3.3 |
| | | 2-methylbutanal | 26.9 ± 2.2 |
| | | 3-methylbutanal | 76.7 ± 7.0 |
| | | hexanal | 5.2 ± 0.2 |
| | | furfural | 119.8 ± 0.6 |
| | | methional | 89.9 ± 3.9 |
| | | benzaldehyde | 2.9 ± 0.0 |
| | | phenylacetaldehyde | 114.5 ± 8.2 |
| | | (E)-2-nonenal | 0.16 ± 0.2 |

*DMS = dimethyl sulphide;
**DMSP = dimethyl sulphide precursor;
***dp3 = maltotriose;
****dp4 = maltotetraose;
*****dp5 = maltopentaose;
†dp6 = maltohexaose;
††dp7 = maltoheptaose;
†††dp8 = maltooctaose

TABLE 2
Results for worts obtained with the fragmented kiln
malt according to Example 3

| | | | |
|---|---|---|---|
| Wort before | DMS* (ppb) | | 184.6 ± 7.6 |
| cooking | | | |
| | DMSP** (ppb) | | 131.2 ± 13.9 |
| | Aldehydes (ppb) | 2-methylpropanal | 205.0 ± 31.7 |
| | | 2-methylbutanal | 129.0 ± 14.7 |
| | | 3-methylbutanal | >121 |
| | | hexanal | 26.4 ± 2.9 |
| | | furfural | 101.6 ± 0.9 |
| | | methional | 187.7 ± 5.6 |
| | | benzaldehyde | 7.3 ± 0.2 |
| | | phenylacetaldehyde | 175.7 ± 0.1 |
| | | (E)-2-nonenal | 0.2 ± 0.0 |
| | Sugars (g/l) | glucose | 16.3 ± 0.8 |
| | | maltose | 96.1 ± 2.1 |
| | | dp3*** | 31.9 ± 0.2 |
| | | dp4**** | 11.5 ± 0.1 |
| | | dp5***** | 2.7 ± 0.3 |
| | | dp6† | 1.8 ± 0.2 |
| | | dp7†† | 2.4 ± 0.1 |
| | | dp8††† | 3.2 ± 0.2 |
| Wort end of | DMS (ppb) | | 5.1 ± 0.3 |
| cooking | | | |
| | DMSP (ppb) | | 14.0 ± 0.1 |
| | Aldehydes (ppb) | 2-methylpropanal | 20.4 ± 1.7 |
| | | 2-methylbutanal | 12.1 ± 1.2 |
| | | 3-methylbutanal | 39.9 ± 3.9 |
| | | hexanal | 3.1 ± 0.3 |
| | | furfural | 561.8 ± 24.8 |
| | | methional | 85.3 ± 2.7 |
| | | benzaldehyde | 3.0 ± 0.1 |
| | | phenylacetaldehyde | 98.8 ± 4.2 |
| | | (E)-2-nonenal | 0.12 ± 0.0 |

*DMS = dimethyl sulphide;
**DMSP = dimethyl sulphide precursor;
***dp3 = maltotriose;
****dp4 = maltotetraose;
*****dp5 = maltopentaose;
†dp6 = maltohexaose;
††dp7 = maltoheptaose;
†††dp8 = maltooctaose

Table 3 shows results of a beer obtained from the fragmented green malt and a beer obtained from the fragmented kiln malt.

TABLE 3
Results of a beer obtained from the fragmented green malt (green malt beer)
and a beer obtained from the fragmented kiln malt (kiln malt beer),
according to Example 3.

| | green | kiln |
|---|---|---|
| | malt beer | malt beer |
| alcohol (% v/v) | 6.36 | 5.07 |
| alcohol (% w/w) | 4.99 | 3.95 |
| Density (g/l) | 1.00709 | 1.01204 |
| Specific density (g/l) | 1.00891 | 1.01386 |
| Er (real extract) (% w/w) | 4.55 | 5.37 |
| Ea (apparent extract) (% w/w) | 2.29 | 3.54 |
| ° P (original extract) (% w/w) | 14.11 | 12.99 |
| RDF (true fermentation rate) (% w/w) | 69.35 | 60.36 |
| ADF (apparent fermentation rate) (% w/w) | 83.80 | 72.72 |
| FAN (free amino nitrogen) (mg/l) | 109.82 | 47.54 |
| Stdev. | 6.58 | 5.09 |
| Soluble protein (mg/l) | 398.75 | 414.88 |
| Stdev. | 14.61 | 6.19 |
| DMS* (ppb) | 27.23 | 8.41 |
| DMSP** (ppb) | 12.60 | 1.15 |

*DMS = dimethyl sulphide;
**DMSP = dimethyl sulphide precursor

1. A method for optimising green malt for a brewing process, wherein the green malt is cut up into cut green malt in a first fragmentation step and wherein the cut-up green malt is ground into fragmented green malt in a second fragmentation step, wherein in the first fragmentation step the green malt is temporarily retained in perforations of a perforated body while a portion of the green malt protrudes from the body, which protruding portion of the retained green malt is cut up with a blade, and following which the thus cut-up green malt is moved through perforations of the perforated body.

2. The method according to claim 1, wherein the green malt is soaked in a water solution at a temperature of 70 to 85° C. and a pH of 3.8 to 4.6.

3. The method according to claim 1, wherein after the first fragmentation step and before the second fragmentation step, during the second fragmentation step, or after the second fragmentation step, the green malt is soaked in a water solution at a temperature of 70 to 85° C. and a pH from 3.8 to 4.6.

4. The method according to claim 3, wherein the perforations are oriented according to an oblique angle with respect to a surface of the perforated body through which the thus cut-up green malt enters the body at a start of a movement through the body.

5. The method according to claim 3, wherein the blade rotates in a direction of rotation when cutting up the green malt and wherein the perforations are arranged in a pattern of curved lines in the perforated body, wherein the curved lines run from a central part to a peripheral part of the body and wherein at least 70% of the curved lines have a substantially equal bend and a substantially equal bending direction from the central part to the peripheral part, the bending direction being directed according to the direction of rotation of the blade.

6. The method according to claim 3, wherein after moving the green malt through perforations of the perforated body, a jet of a water solution is sprayed on the green malt substantially transverse to a direction in which the green malt moves through the body in the first fragmenting step, and wherein subsequently a second jet of a water solution is sprayed on the green malt in a direction substantially transverse to the first direction and substantially parallel to a surface of the perforated body through which the thus cut-up green malt leaves the body at the end of its movement through the perforations.

7. The method according to claim 5, wherein the blade rotates at a speed of 2000 to 4000 rotations per minute.

8. The method according to claim 3, wherein the blade and the perforated body are spaced apart at a maximum distance of 2.5 mm.

9. The method according to claim 1, wherein in the second fragmenting step the cut-up green malt is ground by putting the cut-up green malt between a static rough stone body and a rotating rough stone body, wherein the static rough stone body and the rotating rough stone body are spaced at least 0.0001 mm and at most 1 mm apart.

10. A device for optimising green malt for a brewing process, comprising:
a cutting device configured to cut up green malt into thus cut-up green malt; and
a grinding device in series with the cutting device, the grinding device connected to the cutting device, the grinding device configured to grind the cut-up green malt into thus fragmented green malt,
wherein the cutting device comprises a housing provided on one side with a first opening for receiving green malt and provided on the other side with a second opening for allowing the cut-up green malt to flow away,
wherein within the housing a counterweight, a perforated disc with perforations to hold the green malt and a cutting assembly comprising a blade are arranged around a central rotatable and drivable shaft,
wherein the cutting assembly faces the first opening, the counterweight faces the second opening and the perforated disc is located between the cutting assembly and the counterweight, and
wherein the cutting assembly and the counterweight are to be connected to the shaft.

11. (canceled)

12. The device according to claim 10, wherein the blade is designed as a downwardly directed wing-shaped body, the body comprising two wings (48, 49) situated in line which, when in use, are directed downward towards the perforated disc of the cutting device, and the two wings are provided with a cutting surface on one side of the two wings which, when in use, faces the perforated disk.

13. The device according to claim 10, wherein the perforations extend obliquely through the perforated disc.

14. The device according to claim 10, wherein between the first opening of the housing of the cutting device and the cutting assembly, a liquid pipe is provided which allows for a liquid connection to the housing, and/or wherein, between the second opening of the housing of the cutting device and the counterweight, a liquid pipe is provided which allows for a liquid connection to the housing.

15. The device according to claim 10, wherein in the housing of the cutting device and facing the counterweight, a first and a second spray tube, each including a spray tube body ending in a nozzle are provided, the spray tube bodies (60, 61) are in line with each other, and wherein the nozzle of the first spray tube faces the counterweight, and the nozzle of the second spray tube is oriented at an angle of 80° to 100° in relation to the spray tube body of the second spray tube.

16. The device according to claim 10, wherein the grinding device comprises a housing having a first opening for receiving cut-up green malt on one side and a second opening for letting fragmented green malt flow away on the other side, and wherein within the housing are provided a rough dynamic stone disk to be centrally connected around a rotatable central axis and a rough static stone disk comprising a central cavity, the rough static stone disc and the rough dynamic stone disc being positioned opposite each other and wherein the central cavity of the static stone disc faces the dynamic stone disc, and wherein the static stone disk faces the first opening and the dynamic stone disk faces the second opening.

17. The device according to claim 16, wherein between the first opening of the housing of the grinding device and the static stone disc a liquid pipe is provided which allows for a liquid connection to the housing, and/or wherein, between the second opening of the housing of the grinding device and the dynamic stone disc, a liquid pipe is provided which allows for a liquid connection to the housing.

18. Use of a device according to claim 10 in a method for optimising green malt for a brewing process according to claim 1.

19. A suspension of fragmented green malt, optimised for a brewing process, obtainable by subjecting green malt to a method according to claim 1.

20. The method according to claim 1, wherein the green malt is soaked in a water solution at a temperature of 82° C., and a pH of 4.0.

21. The method according to claim 1, wherein in the second fragmenting step the cut-up green malt is ground by putting the cut-up green malt between a static rough stone body and a rotating rough stone body, wherein the static rough stone body and the rotating rough stone body are spaced 0.02 mm apart.
